(19) United States
(12) Patent Application Publication
(10) Pub. No.: US 2009/0172508 A1
(43) Pub. Date: Jul. 2, 2009

(54) PORTABLE MEDIA DEVICE THAT AUTOMATICALLY CONFIGURES ITSELF AND/OR AN EXTERNAL MEDIA PRESENTATION DEVICE USING PREVIOUSLY-CAPTURED PRESENTATION DATA

(75) Inventor: CHRISTOPHER K. KARSTENS, APEX, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/968,225

(22) Filed: Jan. 2, 2008

(51) Int. Cl. G06F 17/00

(52) U.S. Cl. 715/201

(57) ABSTRACT

The present invention discloses a system that enables a portable media device to automatically capture presentation data for the automatic configuration of a media presentation device. Such a system can include a portable media device, and a presentation configuration manager. The portable media device can be configured to store media files and interface with media presentation devices. The presentation configuration manager can be configured to automatically capture user-modifications to the presentation settings of a media presentation device during the presentation of a media file. The user-modifications can be stored as media presentation data associated with the media file and the media presentation device. The media presentation data can be used to automatically configure the media presentation device for subsequent presentations of the media file.

### BACKGROUND

1. Field of the Invention

The present invention relates to the field of portable media devices and, more particularly, to a portable media device that automatically configures itself and/or an external media presentation device using previously-captured presentation data.

2. Description of the Related Art

The use of portable media devices has become commonplace. Many existing portable electronic devices have branched into media presentation to compete with devices designed specifically for portable media access, such as IPODs. For example, mobile phones are often capable of downloading and presenting video and audio files.

Many of these portable media devices are capable of interfacing with external, more robust media presentation devices, such as computer and home theater systems. This capability greatly increases the convenience, attractiveness, and usability of such devices.

However, when playing a media file from a portable media device on an external presentation device, the presentation settings of the presentation device often require additional adjustment. Such adjustments must be made every time a user desires to access the media file on the external presentation device. This situation is compounded if a user frequently uses the portable media device with various external presentation devices. For example, playing an audio track when connected to a car stereo system requires different tuning than when connected to a mini-speaker set.

What is needed is a portable media device that captures adjustments made to a media presentation device for a specific media file and automatically applies them when the media file is subsequently presented on the same external device. That is, the portable media device records a user's configuration of the presentation device in order to provide the same configuration when the media file is next accessed on the media presentation device. For example, when an audio track is played from a portable media device on a car stereo, a user-adjustment of the treble level is captured and used for all subsequent presentations of the audio track through the car stereo.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system that enables a portable media device to automatically configure a media presentation device using previously-captured presentation data in accordance with embodiments of the inventive arrangements disclosed herein.

FIG. 2 is a table of sample media presentation data for automatically configuring a media presentation device in accordance with an embodiment of the inventive arrangements disclosed herein.

FIG. 3 is a flow chart of a method for automatically configuring a media presentation device using previously-captured presentation data in accordance with an embodiment of the inventive arrangements disclosed herein.

### DETAILED DESCRIPTION OF THE INVENTION

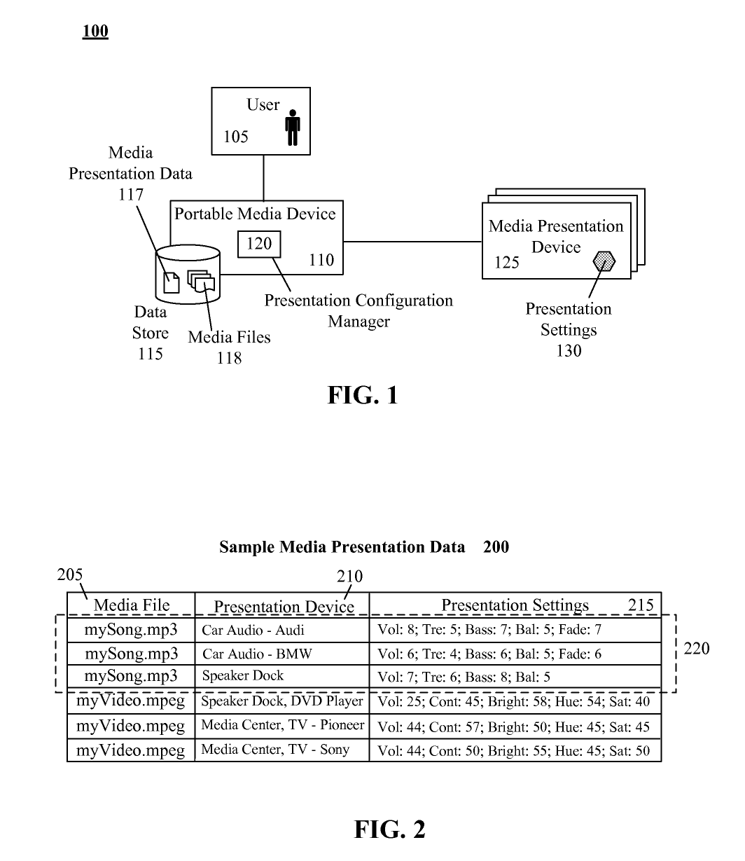

FIG. 1 is a schematic diagram illustrating a system 100 that enables a portable media device 110 to automatically configure a media presentation device 125 using previously-captured presentation data 117 in accordance with embodiments of the inventive arrangements disclosed herein. The media presentation device 125 can be a device external to the portable media device or can be a presentation component of the portable media device 120. Thus, the configurations initiated by the media device 110 can apply presentation adjustments to itself and/or to an external device depending on implementation specifics.

In system 100, a user 105 can select a media file 118 for presentation on the connected media presentation device 125. The presentation configuration manager 120 can automatically adjust the presentation settings 130 of the media presentation device 125 to match the media presentation data 117 for the selected media file 118.

The media presentation device 125 can represent an electronic device that can present the contents of a media file 118; presentation of the media file 118 can be performed external or internal to the portable media device 110. For example, viewing a video file on a computer monitor and not the display of a video IPOD, viewing the video file on the video IPOD, and/or viewing the video file on both the computer monitor and the video IPOD (with different display settings applied to each).

The presentation device 125 can represent a variety of devices, including, but not limited to, a vehicle audio system, a vehicle video system, a television, a personal computer, a home theater system, a home stereo system, a speaker set, and the like. It should be noted that the format of the media file being accessed must be supported by the media presentation device 125 being used.

The media presentation device 125 can include a set of presentation settings 130. The presentation settings 130 can represent user-modifiable attributes of the presentation device 125 that can affect the presentation of the media file 118. For example, color balance, brightness, and contrast can be presentation settings 130 of a video presentation device 125.

The media presentation device 125 can be communicatively connected to the portable media device 110. This connection can be realized in a variety of way, including, but not limited to, a universal serial bus (USB) cable, a wireless network connection, a local area network (LAN) connection, a radio broadcast, a wide area network (WAN) connection, and the like.

In another contemplated embodiment, an intermediary media device (not shown) can be connected between the portable media device 110 and a media presentation device 125. The intermediary device can be configured to provide additional or enhanced functionality to the media presentation device 125. Examples of an intermediary device can include a digital receiver, an amplifier, a media center computer, and the like.

The portable media device 110 can represent an electronic device that provides portability for the presentation of media files 118. Examples of portable media devices 110 can include, but are not limited to, an IPOD, a MP3 player, a compact disc (CD) player, a digital video disk (DVD) player, a multimedia-enabled mobile phone, a portable video game player, a network media player, a media extender, a video camera, and the like.

The portable media device 110 can include a presentation configuration manager 120 and a data store 115 containing media files 118 and media presentation data 117. The presentation configuration manager 120 can be a software application that automatically adjusts the presentation settings 130 of the media presentation device 125 based upon available media presentation data 117. Additionally, the presentation configuration manager 120 can capture changes made by the user 105 to the presentation settings 130 and store the changes as media presentation data 117.

The media presentation data 117 can correlate a media file 118 with user-adjusted presentation settings 130 for a specific media presentation device 125. For example, changes made to the contrast and brightness of Television XYZ while watching Video A can be stored as a table record that is applicable only to Video A when viewed on Television XYZ. In one embodiment, the media presentation data 117 can be stored as metadata of the media file 118. This can advantageously permit the presentation data to be copied to other portable devices when copied, should such a configurable option be selected by user 105.

In another embodiment, the media presentation data 117 can provide a media file 118 agnostic setting (default setting for a media presentation device 125), which is to be used for the device 125 when playing media files 118 from device 120 that do not have a specific media presentation data 117 file associated with them. Additionally, one media presentation data 117 specification can apply to a definable set of media files 118, which can have similar characteristics.

Because different media files 118 can be digitally encoded for different playback levels (e.g., volume can vary greatly among different stored digital music files), it can be advantageous to use specific associated files 117 than to rely heavily upon defaults established for a particular device 125. One alternative to this is to establish a baseline parameter for a baseline file and to automatically adjust one or more values of the media presentation data 117 (that controls a set of media files 118) based upon differences between a baseline file and a particular media file 118. In other words, the settings established within data 117 can be relative settings from a baseline, instead of being absolute settings to be applied regardless of the characteristics of a media file 118. For instance, presentation data 117 can establish a volume for the device 125 relative to a baseline volume, before the volume setting of data 117 is applied to a media file 118, the volume of that file 118 can be determined and adjusted to match the baseline volume (or the volume from data 117 can be adjusted to account for differences between the baseline volume and that of file 118).

It should be emphasized that the identification of the presentation data 117 by the media file 118 and presentation device 125 is a critical element of the present invention. The portable media device 110 can be connected to a multitude of varying presentation devices 125 with different presentation capabilities. Therefore, it is paramount to associate the exact presentation device 125 and setting 130 values with the media file 118 in order to ensure proper configuration for subsequent uses. For example, attempting to use the presentation data 117 stored when the user 105 viewed Video A on Television XY1 when viewing Video A on Television XY2 can dramatically change the viewing experience.

It is also important to note that capturing adjustments made to the presentation settings 130 of a presentation device 125 for future use is not a feature of contemporary portable media devices 110. Currently, adjustments must be made every time the portable media device 110 is reconnected to the presentation device 125.

As used herein, presented data stores, including store 115, can be a physical or virtual storage space configured to store digital information. Data store 115 can be physically implemented within any type of hardware including, but not limited to, a magnetic disk, an optical disk, a semiconductor memory, a digitally encoded plastic memory, a holographic memory, or any other recording medium. The data store 115 can be a stand-alone storage unit as well as a storage unit formed from a plurality of physical devices. Additionally, information can be stored within data store 115 in a variety of manners. For example, information can be stored within a database structure or can be stored within one or more files of a file storage system, where each file may or may not be indexed for information searching purposes. Further, data store 115 can utilize one or more encryption mechanisms to protect stored information from unauthorized access.

FIG. 2 is a table 200 of sample media presentation data for automatically configuring a media presentation device in accordance with an embodiment of the inventive arrangements disclosed herein. The sample media presentation data of table 200 can be used in the context of system 100 or any other system supporting the automatic configuration of a media presentation device by a portable media device using previously-captured presentation data. It should be emphasized that table 200 is for illustrative purposes only and is not meant as an absolute implementation or limitation of the present invention.

In this example, the table of sample media presentation data 200 includes columns indicating the media file 205, the external media presentation device 210, and the presentation settings 215. The text items listed in the media file 205 column can correspond to media files stored on the portable media device.

Items listed in the presentation device 210 column can correspond to various media presentation devices for which the portable media device has captured data. The presentation settings 215 column can contain the captured settings of the listed presentation device 210.

The relationship and usage of the sample media presentation data 200 is best illustrated with an example using a set of sample data 220. As shown, the sample data 220 contains three rows or records of data. All three rows pertain to the media file 205 entitled “mySong.mp3”. However, each row of data 220 is for a different presentation device 210. Further, each row contains a set of captured presentations settings 215 for listening to “mySong.mp3” on the specific presentation device 210.

When the user plugs the portable media device into the audio system of his AUDI to listen to “mySong.mp3”, the audio system's volume is changed to level 8, the treble to level 5, the bass to level 7, the balance to level 5, and the fade to level 7.

When the user plugs the portable media device into the audio system of his wife's BMW to listen to “mySong.mp3”, the audio system's volume is changed to level 6, the treble to level 6, the bass to level 6, the balance to level 5, and the fade to level 6. When the user plugs the portable media device into its speaker dock at home to listen to “mySong.mp3”, the speaker dock's volume is changed to level 7, the treble to level 6, the bass to level 8, and the balance to level 5. Fade cannot be included in the presentation settings 215 for the speaker dock because it is either not a setting supported by the speaker dock and/or its level was not changed by the user.

It should be noted that the values of the presentation settings of the presentation device 210 prior to listening to “mySong.mp3” are irrelevant. That is, even if the media file accessed prior to “mySong.mp3” has a completely contrary set of presentation settings 215, the presentation device 210 settings 215 can be modified to the listed values.

Further, if a presentation setting 215 of the presentation device 210 is not accounted for, such as the speaker dock not having a value for fade, the current value of the presentation device 210 can be used. For example, should the speaker dock support a fade setting 215, “mySong.mp3” would be played with whatever value for fade that was last input. If this current value is undesired by the user, then the user can make a modification to the fade level, which can then be captured and store in the table 200 for the next time “mySong.mp3” is played on the speaker dock.

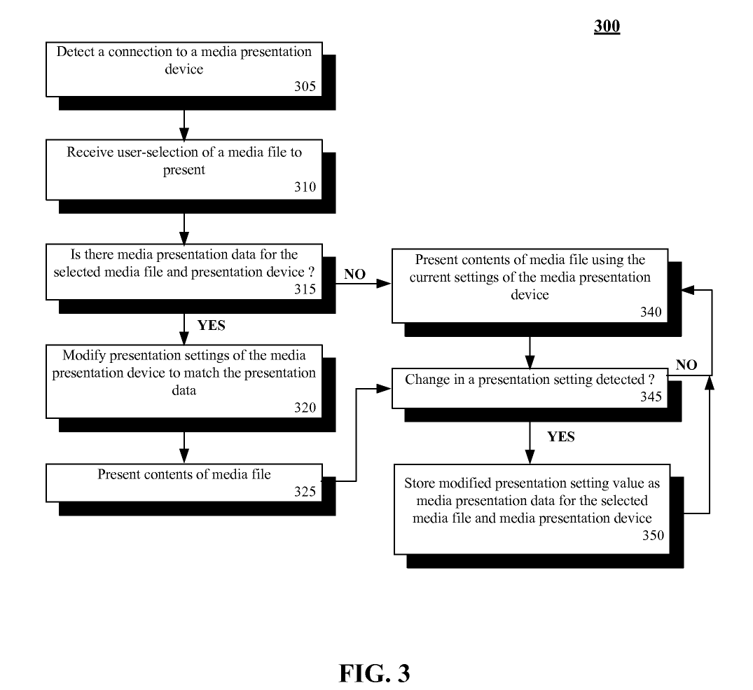

FIG. 3 is a flow chart of a method 300 for automatically configuring a media presentation device using previously-captured presentation data in accordance with an embodiment of the inventive arrangements disclosed herein. Method 300 can be performed in the context of system 100 and/or utilize the sample media presentation data of FIG. 2.

Method 300 can begin with step 305 where a connection to a media presentation device can be detected. In step 310, the user-selection of a media file to present upon the media presentation device can be received.

The presence of media presentation data for the selected media file and connected media presentation device can be determined in step 315. When media presentation data exists, step 320 can execute in which the presentation settings of the media presentation device can be modified to match the media presentation data.

In step 325, the contents of the media file can be presented. Flow can then proceed to step 345.

When media presentation data does not exist, step 340 can execute in which the contents of the media file can be presented using the current settings of the media presentation device. In step 345, a change in a presentation setting can be detected.

When a change is detected, step 350 can execute where the modified presentation setting value can be stored as media presentation data for the media file and media presentation device. When a change is not detected in step 345, flow can return to step 340, continuing the presentation of the media file contents.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A system for automatically capturing presentation settings for the media files of a portable media device when presented on various media presentation devices comprising:
a portable media device configured to store a plurality of media files and interface with a plurality of media presentation devices; and
a presentation configuration manager configured to automatically capture user-modifications to a set of presentation settings of a media presentation device during a presentation of a user-selected media file, wherein said user-modifications to the set of presentation settings of the media presentation device are stored as media presentation data associated with media presentation device, wherein said media presentation data is used to automatically configure said media presentation device for subsequent presentations of media files.

2. The system of claim 1, wherein said media presentation data is also associated with said media file, and wherein the subsequent presentations of media files to which the media presentation data applies is limited to the subsequent presentations of said media file.

3. The system of claim 2, wherein said media presentation data is contained in metadata of said media file.

4. The system of claim 1, wherein said media presentation data is associated with a defined set of a plurality of media files, wherein subsequent presentation of media files contained in the defined set are presented in accordance with said media presentation data.

5. The system of claim 1, further comprising:
an intermediary media device connected to both the portable media device and the media presentation device, wherein the intermediary media device is configured to operate in conjunction with the media presentation device for the presentation of the media file, wherein the presentation configuration manager identifies a combination of the intermediary media device with the media presentation device in the media presentation data for the media file.

6. The system of claim 5, wherein at least one presentation setting of the set of presentation settings of the media presentation device is modifiable via the intermediary media device, wherein the presentation configuration manager captures a user-modification to the at least one presentation setting for storage as media presentation data for the media file.

7. The system of claim 5, wherein the intermediary media device is at least one of a digital receiver, an amplifier, a multimedia computing system, an audio system, and a video system.

8. The system of claim 1, wherein the plurality of media files are stored on a removable media.

9. The system of claim 1, wherein the set of presentation settings includes at least one of a volume, a bass level, a treble level, an audio balance level, a hue level, a color saturation level, a color balance level, a brightness level, and a contrast level.

10. A method for using previously-captured presentation data to automatically configure the presentation settings of a media presentation device when presenting a user-specified media file from a portable media device comprising:
establishing a communications connection to an external media presentation device by a portable media device;
receiving a user-selection of a media file for presentation upon the external media presentation device;
determining an existence of media presentation data for the user-selected media file and the external media presentation device, wherein said media presentation data corresponds to a user-configuration of the external media presentation device during a previous presentation of the media file upon the external media presentation device;
when media presentation data exists, automatically modifying a set of presentation settings for the external media presentation device to match the media presentation data; and
presenting the user-selected media file with the modified set of presentation settings.

11. The method of claim 10, further comprising:
monitoring a presentation of the user-selected media file for a user-modification to at least one presentation setting; and
when the user-modification is identified, capturing and storing said user-modification as media presentation data for the media file and the external media presentation device.

12. The method of claim 10, wherein the determining and modifying steps are performed by a presentation configuration manager on the portable media device.

13. The method of claim 10, wherein the portable media device is at least one of a multimedia-enabled portable phone, a laptop computer, a portable video player, and a portable audio player.

14. The method of claim 10, wherein the external media presentation device is one of a television, a personal computer, a multimedia computing system, a vehicular media system, and an audio system.

15. The method of claim 10, wherein an intermediary media device is connected to both the portable media device and the external media presentation device, wherein the intermediary media device is configured to operate in conjunction with the external media presentation device for the presentation of the media file, wherein a combination of the intermediary media device with the external media presentation device is stored as part of the media presentation data for the media file.

16. The method of claim 10, wherein the communications connection is one of a wireless network connection, a universal serial bus (USB) cable, a radio broadcast, a local area network (LAN) connection, a wide area network (WAN) connection, and a personal area network.

17. The method of claim 10, wherein said steps of claim 10 are performed by at least one machine in accordance with at least one computer program stored in a computer readable media, said computer programming having a plurality of code sections that are executable by the at least one machine.

18. A portable media device that automatically configures an external media presentation devices for previous user settings comprising:
a set of media files useable by a portable media device;
a set of media presentation data representing at least one user-modified presentation setting, wherein each data grouping in the set of media presentation data is associated with a media file in the set of media files and an external media presentation device; and
a presentation configuration manager configured to automatically adjust a set of presentation settings of the media presentation device to match a data grouping of the set of media presentation data, wherein adjustment occurs prior to a presentation of the media file on the media presentation device.

19. The portable media device of claim 18, wherein the media presentation device is one of a television, a personal computer, a multimedia computing system, a vehicular media system, and an audio system.

20. The portable media device of claim 18, wherein the set of presentation settings includes at least one of a volume, a bass level, a treble level, an audio balance level, a hue level, a color saturation level, a color balance level, a brightness level, and a contrast level.
